(19) United States
(12) Patent Application Publication
(10) Pub. No.: US 2025/0153620 A1
(43) Pub. Date: May 15, 2025

(54) FLUID SYSTEM FOR A VEHICLE SEAT ASSEMBLY

(71) Applicant: LEAR CORPORATION, Southfield, MI (US)

(72) Inventors: Grzegorz Kasperczyk, Warszawa (PL); Samuel Blair, Rochester, MI (US); David Abdella, Farmington Hills, MI (US)

(21) Appl. No.: 18/826,332

(22) Filed: Sep. 6, 2024

Related U.S. Application Data
(60) Provisional application No. 63/599,174, filed on Nov. 15, 2023.

(51) Int. Cl. B60N 2/66; B60N 2/90

(52) U.S. Cl. CPC B60N 2/665; B60N 2/976

(57) ABSTRACT

An assembly includes a plurality of fluid bladders including at least a first fluid bladder and a second fluid bladder, and a fluid manifold in fluid communication with the plurality of bladders. The fluid manifold includes at least a first passage and a second passage. A first port fluidly connects the first fluid bladder to the first passage, a second port fluidly connects the second fluid bladder to the first passage, and a third port fluidly connects the second fluid bladder to the second passage. A first check valve is positioned in the second passage and is moveable between a first position, where fluid enters the third port and inflates the second fluid bladder, and a second position where fluid is directed through the third port to a vent.

### RELATED APPLICATIONS

This application claims the benefit of U.S. Provisional Application No. 63/599,174, filed Nov. 15, 2023, the entirety of which is herein incorporated by reference.

### BACKGROUND

Seat assemblies may include one or more inflatable bladders.

### BRIEF DESCRIPTION OF THE DRAWINGS

FIG. 1 illustrates a perspective schematic view of a seat assembly according to an embodiment;

FIG. 2 illustrates a top view of a bladder assembly according to an embodiment and for use with the vehicle seat assembly of FIG. 1 shown in a filling condition;

FIG. 3 illustrates a top view of the bladder assembly of FIG. 2 shown in a venting condition;

FIG. 4 illustrates a top view of a bladder assembly according to another embodiment and for use with the vehicle seat assembly of FIG. 1 shown in a filling condition; and

FIG. 5 illustrates a top view of the bladder assembly of FIG. 4 shown in a venting condition.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

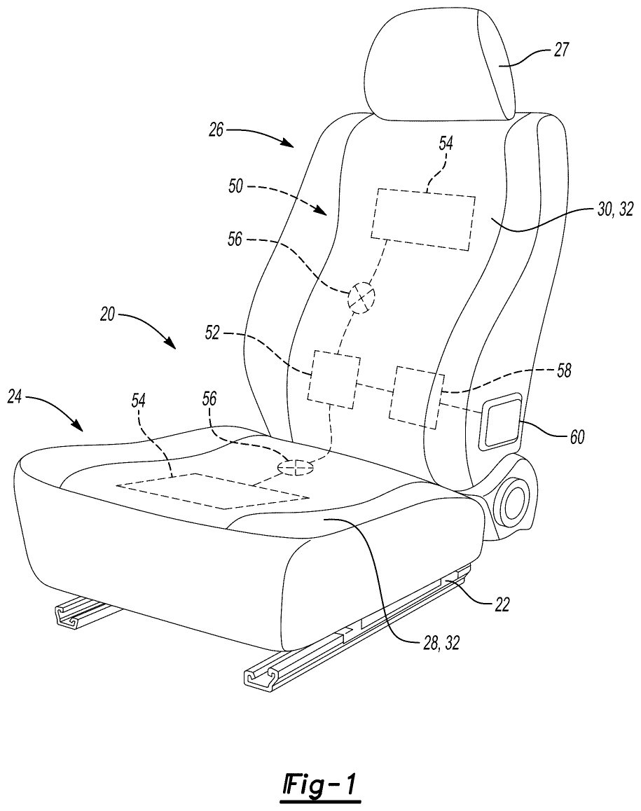

Referring to FIG. 1, a seat assembly 20, such as a vehicle seat assembly 20 is illustrated. In other examples, the seat assembly 20 may be shaped and sized as a front row driver or passenger seat, a second, third, or other rear row seat, and may include bench-style seats as shown, bucket seats, or other seat styles. Furthermore, the seat assembly may be a non-stowable seat or a stowable seat that may be foldable and stowable in a cavity in the vehicle floor. Additionally, the seat assembly 20 may be configured for use with other non-vehicle applications.

The seat assembly 20 has a support structure 22 that may be provided by one or more support members. A support member may be provided by a frame and/or a substrate. The seat assembly has seat components, and these seat components include at least a seat bottom 24 and a seat back 26. The seat bottom 24 may be sized to receive a seated occupant to support a pelvis and thighs of the occupant. The seat back 26 may be sized to extend upright from the seat bottom 24 to support a back of the occupant. The seat assembly may additionally have a head restraint 27. The seat bottom 24 has a seat bottom cushion 28. The seat back 26 has a seat back cushion 30. The support structure 22 provides rigid structural support for the seat components, e.g. the seat bottom 24 and seat back 26, and the associated cushions 28, 30. One or more trim assemblies 32 are used to cover the seat bottom cushion 28 and/or the seat back cushion 30, and provide a seating surface for the seat assembly 20.

In implementations, the seat assembly 20 has one or more fluid systems 50, such as an air system. Although only one fluid system 50 is shown, it is also contemplated that the seat assembly 20 may have two or more fluid systems 50. The fluid system 50 has a fluid supply or transfer device 52 to provide pressurized fluid flow or air flow to one or more bladder assemblies 54 in the seat assembly 20. The fluid transfer device 52 may be a fan, air pump, compressor, blower, pump, or the like to provide flow of a fluid. The seat assembly 20 is shown with two bladder assemblies; however the seat assembly 20 may have only one bladder assembly or more than two bladder assemblies.

In implementations, bladders comprise discrete inflatable/deflatable pouches or cells that are utilized for massage, lumbar, and/or bolster purposes. In one example, when in an inflation condition, a bladder will expand due to an increase in fluid pressure, and when in a deflation condition, a bladder will contract due to a decrease in fluid pressure.

In implementations, the fluid system 50 may provide a massage function, for example via bladders positioned within the seating component(s); a lumbar control function with one or more bladders positioned within the seating component(s); or other seat position controls with bladders appropriately positioned in the seating component(s), e.g. to control the angle or tilt of cushion and associated support pan of the seat component relative to its associated frame 22. In other examples, the fluid system 50 may be used for other seat functions and/or features as are known in the art. The fluid system 50 may provide fluid flow to one or more of the bladder assemblies 54 for static inflation where the bladder holds its position at a selected inflation level, e.g. for lumbar or seat position functions, or may provide fluid flow to one or more of the bladder assemblies 54 for dynamic inflation where the bladder inflation or position changes, e.g. for massage functions. Furthermore, and for dynamic inflation, the fluid system 50 may be provided with bladder assemblies 54 with one or more bladders that are inflated sequentially with respect to one another. In further examples, the seat assembly 20 may be provided with only a single fluid system, or with more than two fluid systems.

The fluid system 50 may have various valve assemblies 56 and other components. Valve assemblies 56 in the fluid system 50 according to various embodiments are described in further detail below. In some embodiments, the valve assemblies 56 may be used to control fluid flow from the fluid transfer device 52 to one or more of the bladder assemblies 54, as well as to control return flow or venting of the bladder assemblies 54, or to hold or maintain an inflation level of the bladder assemblies.

The valve assemblies 56 and the fluid transfer device 52 may each be in communication with one or more controllers 58 for control of the operation of the fluid system 50, and the inflation or deflation of the bladder assemblies 54. The controller 58 may further be in communication with a user input 60 to allow a seat occupant to control operation of the fluid system, or to select various functions, e.g. massage, massage speed, lumbar level, seat position angle, or the like.

In implementations, a controller may comprise any device for executing software instructions such as one or more processing units and non-transitory memory, input/output devices.

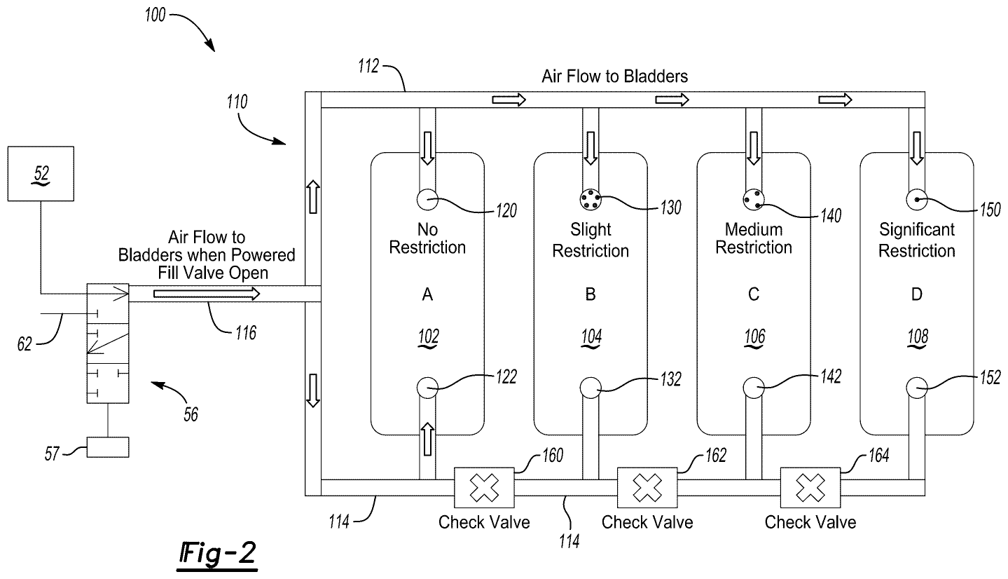

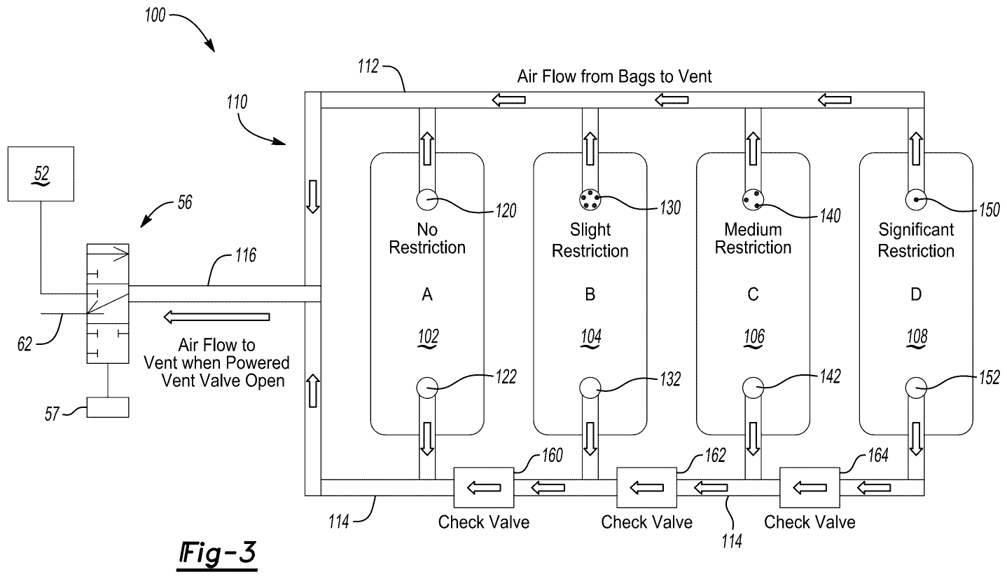

FIGS. 2-3 illustrate a bladder assembly 100 according to an embodiment. In various examples, the bladder assembly 100 may be used with the seat assembly 20 of FIG. 1, and as the bladder assembly 54 in a fluid system 50. FIG. 2 illustrates the bladder assembly 100 in a filling condition or an inflation condition. FIG. 3 illustrates the bladder assembly 100 in a venting condition.

The bladder assembly 100 is shown with a first bladder 102, a second bladder 104, a third bladder 106, and a fourth bladder 108. In other examples, the bladder assembly 100 may be provided with two or three bladders, or with more than four bladders. The bladders 102-108 are shown in a parallel flow configuration, and for sequential filling, as is described below. Furthermore, the bladders 102-108 may be arranged in other flow configurations, e.g. in a combination of sequential and parallel fluid flow, e.g. with the third bladder 106 replaced by two or more bladders in series arrangement with one another for filling, and both separately connected to the vent line.

The bladder assembly 100 is fluidly connected to the fluid transfer device 52 via a valve assembly 56. In one example, all of the flow into or out of the bladder assembly 100 passes through the valve assembly 56. In some embodiments, and as shown, the valve assembly 56 is provided as a three position valve. For example, a common, e.g., single, valve is used to provide three different flow positions. In other examples, the valve assembly 56 is provided as a two position valve to allow flow into or out of the bladder assembly 100. In further examples, the valve assembly 56 may be provided by more than one valves to provide similar functions as that described herein. The valve assembly 56 may be controlled via one or more actuators 57, e.g. actuator 57 may be provided by a solenoid, or other actuator, and in various examples, the actuator member 57 is a rod of a linear actuator, such as in a linear solenoid actuator or a shape-memory alloy (SMA) linear actuator. The actuator 57 position may be controlled via the controller 58.

In the example shown, the valve assembly 56 has a first position to allow flow from the fluid transfer device 52 into the bladder assembly 100 for inflation of the bladders (as shown in FIG. 2); a second position to allow flow from the bladder assembly to a vent passage 62, e.g. to atmosphere or to a return line for the fluid system, for deflation of the bladders; and a third position to limit flow into or out of the bladder assembly 100, e.g. to maintain an inflation level of the bladder assembly 100.

The bladder assembly 100 has a fluid manifold 110 connecting the valve assembly 56 to the bladders 102-108. In implementations, a manifold may comprise a series of fluidly connected tubular members and/or passages that connect a fluid supply to an inflatable member, e.g. a bladder. In the embodiment shown, the fluid manifold has a first passage 112, a second passage 114, and a connecting passage 116. In some examples, the fluid manifold 110 may be formed from tubing, such as flexible plastic or vinyl tubing.

Each of the bladders 102-108 may comprise or be formed from one or more layers of material, such as a flexible plastic or vinyl material, thermoplastic polyurethane (TPU), another thermoplastic, or other materials such as rubber or latex. Each of the bladders 102-108 defines a cavity therein to receive fluid. The various layers of each of the bladders may be connected via adhesive, welding, bonding, or another technique as is known in the art. Note that welding may include a process for thermoplastics including heat and/or pressure, ultrasonic joining, or the like. The various layers of each of the bladders may be connected around an outer perimeter region to form the bladder and cavity.

In implementations, the bladders are associated with one or more ports. In one example, a port comprises a connecting opening or passage between components in the fluid system through which fluid can enter or exit.

In implementations, the first bladder 102 has a first port 120 and a second port 122. In other embodiments, the first bladder 102 has only port 120 or port 122. The first and second ports 120, 122 are used to fluidly connect the first bladder 102 to the fluid manifold 110. The first and second ports 120, 122 are shown at opposite end regions of the first bladder 102, but in other examples, the first and second ports may be otherwise positioned on the bladder 102, including being adjacent to one another in one of the end regions. The first port 120 is fluidly connected to the first passage 112, and the second port 122 is fluidly connected to the second passage 114.

The second bladder 104 has a third port 130 and a fourth port 132. The first and second ports 130, 132 are used to fluidly connect the second bladder 104 to the fluid manifold 110. The third and fourth ports 130, 132 are shown at opposite end regions of the second bladder 104, but in other examples, the third and fourth ports may be otherwise positioned on the second bladder 104, including being adjacent to one another in one of the end regions. The third port 130 is fluidly connected to the first passage 112, and the fourth port 132 is fluidly connected to the second passage 114.

The third bladder 106 has a fifth port 140 and a sixth port 142. The fifth and sixth ports 140, 142 are used to fluidly connect the third bladder 106 to the fluid manifold 110. The fifth and sixth ports 140, 142 are shown at opposite end regions of the third bladder 106, but in other examples, the fifth and sixth ports may be otherwise positioned on the third bladder 106, including being adjacent to one another in one of the end regions. The fifth port 140 is fluidly connected to the first passage 112, and the sixth port 142 is fluidly connected to the second passage 114.

The fourth bladder 108 has a seventh port 150 and an eighth port 152. The seventh and eighth ports 150, 152 are used to fluidly connect the fourth bladder 104 to the fluid manifold 110. The seventh and eighth ports 150, 152 are shown at opposite end regions of the fourth bladder 108, but in other examples, the seventh and eighth ports may be otherwise positioned on the fourth bladder 108, including being adjacent to one another in one of the end regions. The seventh port 150 is fluidly connected to the first passage 112, and the eighth port 152 is fluidly connected to the second passage 114.

In implementations, the fluid system may include one or more check valves. In one example, the check valves allow fluid to flow in one direction only. Types of check valves may include a swing check valve, lift check valve, ball check valve, diaphragm check valve, or any other type of one-way valve.

The second passage 114 is provided with check valves. In the example shown, a check valve is provided in the second passage 114 and between each of the ports connected to the second passage 114. Each of the check valves may be provided as passive valve elements that are only controlled based on fluid pressure, or pressure differentials, across the check valve. In the example shown, each check valve is oriented such that the check valve closes when the pressure is higher on the left side of the check valve (when viewing FIGS. 2-3), and opens when the pressure is higher on the right side of the check valve (when viewing FIGS. 2-3). The check valves collectively therefore provide for fluid flow through the second passage 114 and to the connector passage 116, and prevent fluid flow through the second passage 114 away from the connector passage 116 and towards the fourth bladder 108. For the example shown, the bladder assembly 100 therefore has a first check valve 160 in the second passage between the second port 122 and the fourth port 132, a second check valve 162 in the second passage between the fourth port 132 and the sixth port 142, and a third check valve 164 in the second passage between the sixth port 142 and the eighth port 152. In the example shown, the first passage 112 may be provided without check valves such that there is unrestricted flow along the first passage to the first, third, fifth, and seventh ports.

According to various embodiments, the cross-sectional flow area, e.g. an open section area, of the first, third, fifth, and/or seventh ports 120, 130, 140, 150 may vary compared to one another. In other embodiments, the cross-sectional flow area of the first, third, fifth, and/or seventh ports 120, 130, 140, 150 may be the same as one another. Each port may be provided by a single aperture for flow therethrough (as shown for the first port 120), or may be provided with multiple apertures (as shown for ports 130, 140, and 150) that collectively define the cross-sectional flow area. In the non-limiting example shown, the first port 120 has a larger cross-sectional flow area than the second port 130, the second port 130 has a larger cross-sectional flow area than the third port 140, and the third port 140 has a larger cross-sectional flow area than the fifth port 150. Generally, a port with a larger cross-sectional flow area has a higher flow rate therethrough than a port with a smaller cross-sectional flow area.

In some embodiments, the cross-sectional flow area of the second, fourth, sixth, and eighth ports 122, 132, 142, 152 may be the same as one another, and furthermore may be the same as the first port 120. In other examples, the cross-sectional flow area of the second, fourth, sixth, and eighth ports 122, 132, 142, 152 may vary compared to one another. Each port may be provided by a single aperture for flow therethrough (as shown for the ports 122, 132, 142, 152), or may be provided with multiple apertures that collectively define the cross-sectional flow area.

In one example, the bladder assembly 100 is inflated by the pump to modify an orientation of seating surface of the seat member. In other examples, the bladder assembly 100 is inflated by the pump to provide a massage effect to a seat occupant. In one example, the bladder assembly 100 provides a sequential pneumatic massage effect for the seat assembly, and is operated passively (other than control of the valve assembly 56), e.g. sequential inflation and deflation of the bladders of the assembly 100 occur based on the structure and connections between the bladders and the check valves, and not due to active control of any valves interconnecting the individual bladders.

FIG. 2 illustrates a schematic of the bladder assembly 100 during an inflation condition. The controller operates the fluid transfer device 52 and controls the actuator to place the valve assembly 56 in the first position such that pressurized fluid, such as air, flows into the fluid manifold 110 and connecting passage 112. Air also flows into the connecting passage 114 up to the first check valve 160, where it is stopped by the first check valve 160 as the fluid pressure closes the check valve 160. Fluid flows into the first, second, third, and fourth bladders 102-108 to inflate the bladders via the respective first, third, fifth, and seventh ports 120, 130, 140, 150. Fluid also flows into the first bladder 102 to inflate the bladder via the second port 122, as the second port 122 is upstream of the first check valve 160.

Due to the varying cross-sectional flow areas of the ports 120, 130, 140, 150, the bladders 102-108 inflate at varying rates, e.g. the first bladder 102 inflates faster than the second bladder 104, which in turn, inflates faster than the third bladder 106, which in turn, inflates faster than the fourth bladder 108. The first bladder 102 may reach a fully inflated state before the second bladder 104, the second bladder 104 may reach a fully inflated state before the third bladder 106, and likewise, the third bladder 106 may reach a fully inflated state before the fourth bladder 108.

The check valves 160, 162, 164 limit fluid flow from each of the inflating bladders from further inflating an adjacent slower inflating bladder. For example, during inflation, check valve 160 is closed such that the second bladder 104 only inflates via port 130 and does not inflate via port 132. The higher inflation state of the second bladder 104 compared to the third bladder 106 closes the second check valve 162 such that the third bladder 106 only inflates via port 140 and does not inflate via port 142. Likewise, the higher inflation state of the third bladder 106 compared to the fourth bladder 108 closes the third check valve 164 such that the fourth bladder 108 only inflates via port 150 and does not inflate via port 152.

FIG. 3 illustrates a schematic of the bladder assembly 100 during a deflation condition. The controller operates the fluid transfer device 52 and controls the actuator to place the valve assembly 56 in the second position such that fluid, such as air, in the bladder assembly 100 may flow out through vent passage 62, e.g. to atmosphere. Air may flow from each of the bladders 102-108 through the respective ports 120, 130, 140, 150, to the first passage 112, through connecting passage 116 and to the vent passage 62. Additionally, air may flow from each of the bladders 102-108 through the respective ports 122, 132, 142, 152, through the second passage 114, through connecting passage 116 and to the vent passage 62. The check valves 160, 162, 164 may open during the deflation process to allow fluid flow along the second passage 114 to vent and deflate the bladders 102-108. Each of the ports 122, 132, 142, 152 may be similar in size to the first port 120, thereby allowing a rapid and generally simultaneous deflation in comparison to the slower sequential inflation of the bladders 102-108, and limits sequential deflation of the assembly or slow deflation rates.

To maintain an inflation level within the bladder assembly 100, the valve 56 may be positioned in the third position. For the example shown, fluid may flow between bladders 102-108 in the bladder assembly 100, e.g. such that they reach similar pressures and/or inflation levels.

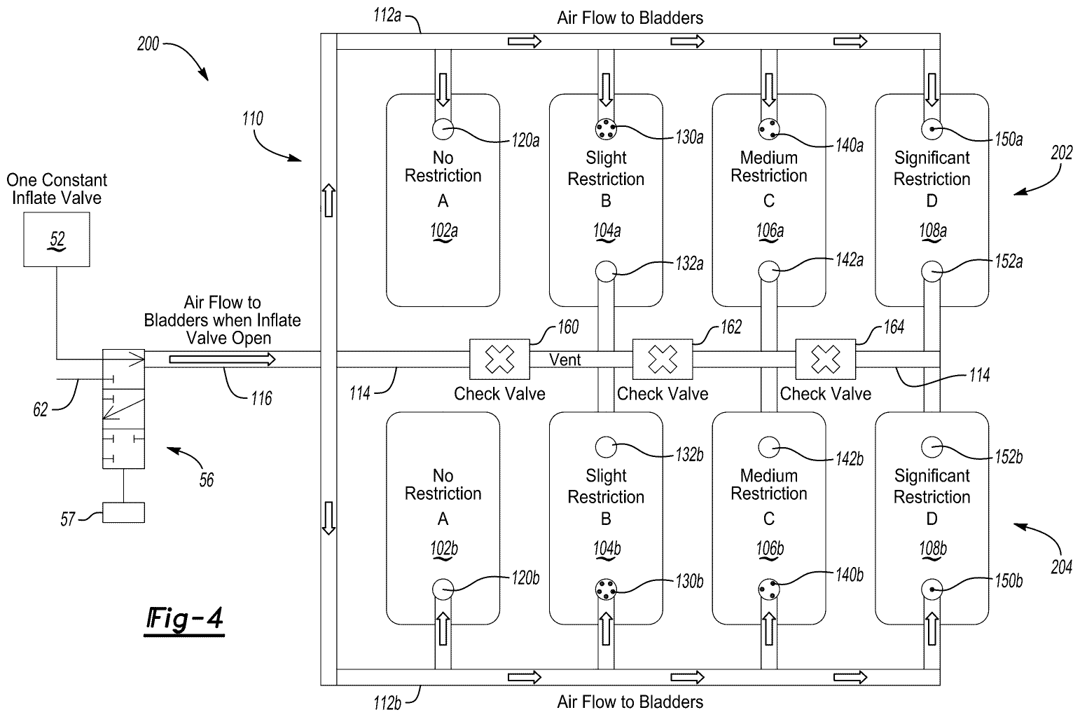

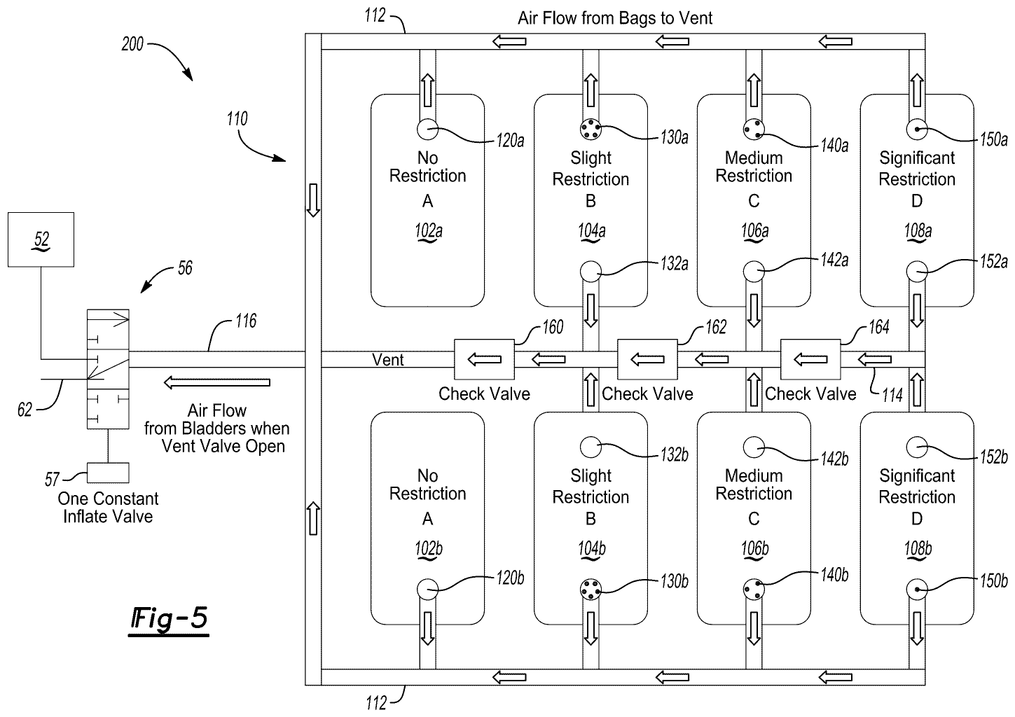

FIGS. 4-5 illustrates a bladder assembly 200 according to another embodiment. In various examples, the bladder assembly 200 may be used with the seat assembly 20 of FIG. 1, and as the bladder assembly 54 in a fluid system 50. Furthermore, the description of the bladder assembly 54, 100, as provided with respect to FIGS. 1-3 may be applied to the bladder assembly 200 as shown in FIGS. 4-5 as appropriate. Reference numbers for elements in FIGS. 4-5 are the same as those used above for elements that are the same as or similar thereto.

The bladder assembly 200 is shown with a first series of bladders 202 with first, second third and fourth bladders 102a, 104a, 106a, 108a in parallel fluid flow arrangement; and a second series of bladders 204 with first, second third and fourth bladders 102b, 104b, 106b, 108b in parallel fluid flow arrangement. In other examples, the bladder assembly 200 may be provided with another number of series of bladders, or with another number of bladders in each series. Furthermore, the bladders may be arranged in other flow configurations.

The first series of bladders 202 is fluidly connected to the connector passage via a first passage 112a, and the second series of bladders 204 is fluidly connected to the connector passage via another first passage 112b.

In the example shown, each of the first bladders 102a, 102b have a single port 120a, 120b, respectively. In other examples, each of the first bladders may be provided with a second port fluidly connecting the bladders to the second passage 114, similar to that shown above in FIGS. 2-3.

Bladders in each of the series of bladders 202, 204 is fluidly connected to a common second passage 114. In the example shown bladders 104a, 106a, 108a, 104b, 106b, and 108b are fluidly connected to the second passage 114 via their respective ports, as bladders 102a, 102b only have a single port. In other examples the bladders 102a, 102b may additionally or alternatively be fluidly connected to the second passage 114.

The first and second series of bladders 202, 204 therefore share check valves 160, 162, 164 in the second passage 114, such that the check valves 160, 162, 164 may close to limit flow to bladders in each of the series 202, 204 during an inflation process or condition, or may open to allow flow from the bladders in each of the series 202, 204 to the second passage 114 and connector passage 116 during a deflation process.

An inflation condition is shown in FIG. 4 for the bladder assembly 200. The controller operates the fluid transfer device 52 and controls the actuator to place the valve assembly 56 in the first position such that pressurized fluid, such as air, flows into the fluid manifold 110 and connecting passages 112a, 112b to the series of bladder assemblies 202, 204. Air also flows into the connecting passage 114 up to the first check valve 160, where it is stopped by the first check valve 160 as the fluid pressure closes the check valve 160. Fluid flows into the first, second, third, and fourth bladders 102a-108a and 102b-108b to inflate the bladders via the respective first, third, fifth, and seventh ports 120a-b, 130a-b, 140a-b, 150a-b, which may inflate at varying rates based on varying cross-sectional flow areas of the associated ports.

The check valves 160, 162, 164 limit fluid flow from each of the inflating bladders from further inflating an adjacent slower inflating bladder. For example, during inflation, check valve 160 is closed such that the second bladders 104a-b only inflates via ports 130a-b and do not inflate via ports 132a-b, respectively. The higher inflation state of the second bladders 104a-b compared to the third bladders 106a-b closes the second check valve 162 such that the third bladders 106a-b only inflates via ports 140a-b and do not inflate via ports 142a-b. Likewise, the higher inflation state of the third bladders 106a-b compared to the fourth bladders 108a-b closes the third check valve 164 such that the fourth bladders 108a-b only inflates via ports 150a-b and do not inflate via port 152.

A deflation condition is shown in FIG. 5 for the bladder assembly 200. The controller operates the fluid transfer device 52 and controls the actuator to place the valve assembly 56 in the second position such that fluid, such as air, in the bladder assembly 200 may flow out through vent passage 62, e.g. to atmosphere. Air may flow from each of the bladders 102a-108a and 102b-108b in each series 202, 204 through the respective ports 120a-b, 130a-b, 140a-b, 150a-b, to the first passages 112a-b, through connecting passage 116 and to the vent passage 62. Additionally, air may flow from each of the bladders 104a-108a and 104b-108b through the respective ports 132a-b, 142a-b, 152a-b, to the second passage 114, through connecting passage 116 and to the vent passage 62. The check valves 160, 162, 164 may open during the deflation process to allow fluid flow along the second passage 114 to vent and deflate the bladders 102a-108a and 102b-108b. Each of the ports 132a-b, 142a-b, 152a-b may be similar in size to the first ports 120a-b, thereby allowing a rapid and generally simultaneous deflation in comparison to the slower sequential inflation of the bladders in each series 202, 204, and limits sequential deflation of the assembly 200 or slow deflation rates.

To maintain an inflation level within the bladder assembly 200, the valve 56 may be positioned in the third position. For the example shown, fluid may flow between series 202, 204, and between bladders 102a-108a and 102b-108b in the bladder assembly 200, e.g. such that they reach similar pressures and/or inflation levels.

In one implementation, an assembly includes: a plurality of fluid bladders including at least a first fluid bladder and a second fluid bladder; a fluid manifold in fluid communication with the plurality of bladders, wherein the fluid manifold includes at least a first passage and a second passage; a first port fluidly connecting the first fluid bladder to the first passage; a second port fluidly connecting the second fluid bladder to the first passage; a third port fluidly connecting the second fluid bladder to the second passage; and a first check valve positioned in the second passage, wherein the first check valve is moveable between a first position where fluid enters the third port and inflates the second fluid bladder, and a second position where fluid is directed through the third port to a vent.

The assembly may include any of the following either alone or in any combination thereof. In one example, a fourth port fluidly connects the first fluid bladder to the second passage, wherein the first check valve is positioned in the second passage between the third port and the fourth port.

In one example, the first check valve is in the first position during an inflation condition for the first fluid bladder and the second fluid bladder, and wherein the first check valve is in the second position during a deflation condition for the first fluid bladder and the second fluid bladder.

In one example, a cross-sectional flow area of the first port is greater than a cross-sectional flow area of the second port.

In one example, the assembly further includes: a fluid supply source; a valve assembly fluidly connecting the fluid supply source to the fluid manifold; and one or more controllers selectively controlling the valve assembly between the first position and the second position.

In one example, the valve assembly comprises a single three position valve.

In one example, a connecting passage fluidly connects the valve assembly to the first passage and the second passage.

In one example, the plurality of bladders includes at least a third bladder, and further including: a fifth port fluidly connecting the third fluid bladder to the first passage; a sixth port fluidly connecting the third fluid bladder to the second passage; and a second check valve positioned in the second passage between the third port and the sixth port, the second check valve being moveable between a first position where fluid enters the sixth port and inflates the third fluid bladder, and a second position where fluid is directed through the sixth port to the vent.

In one example, the plurality of bladders includes at least a fourth bladder, and further including: a seventh port fluidly connecting the fourth fluid bladder to the first passage; an eighth port fluidly connecting the fourth fluid bladder to the second passage; and a third check valve positioned in the second passage between the sixth port and the eighth port, the third check valve being moveable between a first position where fluid enters the eighth port and inflates the fourth fluid bladder, and a second position where fluid is directed through the eighth port to the vent.

In one example, the plurality of fluid bladders including the first fluid bladder and the second fluid bladder comprise a first set of fluid bladders, and wherein the fluid manifold includes a third passage, and further including: a second set of fluid bladders comprising at least a third fluid bladder and a fourth fluid bladder, the second set of fluid bladders being in a parallel fluid flow arrangement with the first set of fluid bladders; a fourth port fluidly connecting the third fluid bladder to the third passage; a fifth port fluidly connecting the fourth fluid bladder to the third passage; a sixth port fluidly connecting the fourth fluid bladder to the second passage; and wherein, when the first check valve is in the first position, where fluid enters the third port and the sixth port and inflates the second fluid bladder and the fourth fluid bladder, and when the first check valve is in the second position, fluid is directed through the third port and the sixth port to the vent.

In one example, a seat component comprises an exterior facing surface, and wherein the first fluid bladder and the second fluid bladder are positioned adjacent to the exterior facing surface.

In one implementation, a seat assembly comprises: a seat component comprising an exterior facing surface; a plurality of fluid bladders associated with the exterior facing surface, the plurality of fluid bladders including at least a first fluid bladder and a second fluid bladder; a fluid manifold fluidly connecting a fluid supply source with the plurality of bladders, wherein the fluid manifold includes at least a first passage and a second passage; a valve assembly fluidly connecting the fluid supply source to the fluid manifold; a first port fluidly connecting the first fluid bladder to the first passage; a second port fluidly connecting the second fluid bladder to the first passage; a third port fluidly connecting the second fluid bladder to the second passage; and a first check valve positioned in the second passage, wherein the first check valve is moveable between a first position where fluid enters the third port and inflates the second fluid bladder, and a second position where fluid is directed through the third port to a vent; and one or more controllers selectively controlling the valve assembly between the first position and the second position.

The seat assembly may include any of the following either alone or in any combination thereof. In one example, a fourth port fluidly connectis the first fluid bladder to the second passage, wherein the first check valve is positioned in the second passage between the third port and the fourth port.

In one example, the first check valve is in the first position during an inflation condition for the first fluid bladder and the second fluid bladder, and wherein the first check valve is in the second position during a deflation condition for the first fluid bladder and the second fluid bladder.

In one example, a cross-sectional flow area of the first port is greater than a cross-sectional flow area of the second port.

In one example, the plurality of bladders includes at least a third bladder, and further including: a fifth port fluidly connecting the third fluid bladder to the first passage; a sixth port fluidly connecting the third fluid bladder to the second passage; and a second check valve positioned in the second passage between the third port and the sixth port, the second check valve being moveable between a first position where fluid enters the sixth port and inflates the third fluid bladder, and a second position where fluid is directed through the sixth port to the vent.

In one example, the plurality of bladders includes at least a fourth bladder, and further including: a seventh port fluidly connecting the fourth fluid bladder to the first passage; an eighth port fluidly connecting the fourth fluid bladder to the second passage; and a third check valve positioned in the second passage between the sixth port and the eighth port, the third check valve being moveable between a first position where fluid enters the eighth port and inflates the fourth fluid bladder, and a second position where fluid is directed through the eighth port to the vent.

In one example, the plurality of fluid bladders including the first fluid bladder and the second fluid bladder comprise a first set of fluid bladders, and wherein the fluid manifold includes a third passage, and further including: a second set of fluid bladders comprising at least a third fluid bladder and a fourth fluid bladder, the second set of fluid bladders being in a parallel fluid flow arrangement with the first set of fluid bladders; a fourth port fluidly connecting the third fluid bladder to the third passage; a fifth port fluidly connecting the fourth fluid bladder to the third passage; a sixth port fluidly connecting the fourth fluid bladder to the second passage; and wherein, when the first check valve is in the first position, where fluid enters the third port and the sixth port and inflates the second fluid bladder and the fourth fluid bladder, and when the first check valve is in the second position, fluid is directed through the third port and the sixth port to the vent.

In one example, the valve assembly comprises a single three position valve.

In one example, a connecting passage fluidly connects the valve assembly to the first passage, the second passage, and the third passage.

In one implementation, an assembly includes a fluid manifold comprising a first passage and a second passage; a first bladder defining a first port fluidly coupled to the first passage; a second bladder defining a third port fluidly coupled to the first passage and a fourth port fluidly coupled to the second passage; and a first check valve positioned in the second passage between the first passage and the fourth port.

The assembly may include any of the following either alone or in any combination thereof. In one example, the first bladder defines a second port fluidly coupled to the second passage; and wherein first check valve is positioned in the second passage between the second port and the fourth port.

In one example, the first check valve is oriented to be in a closed position during an inflation condition for the first and second bladders, and wherein the first check valve is oriented to be in an open position during a deflation condition for the first and second bladders.

In one example, a cross-sectional flow area of the first port is greater than a cross-sectional flow area of the third port.

In one example, the assembly further includes a fluid transfer device; a valve assembly fluidly connecting the fluid transfer device to the fluid manifold; and a controller configured to control the valve assembly between a first position and a second position, wherein the first and second bladders inflate with the valve assembly in the first position, and wherein the first and second bladders deflate with the valve assembly in the second position.

In implementations, a seat assembly may further include a seat member comprising a seating surface; and one or more features as described above, and wherein the first and second bladders are positioned adjacent to the seating surface.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. An assembly comprising:
a plurality of fluid bladders including at least a first fluid bladder and a second fluid bladder;
a fluid manifold in fluid communication with the plurality of bladders, wherein the fluid manifold includes at least a first passage and a second passage;
a first port fluidly connecting the first fluid bladder to the first passage;
a second port fluidly connecting the second fluid bladder to the first passage;
a third port fluidly connecting the second fluid bladder to the second passage; and
a first check valve positioned in the second passage, wherein the first check valve is moveable between a first position where fluid enters the third port and inflates the second fluid bladder, and a second position where fluid is directed through the third port to a vent.

2. The assembly of claim 1, including a fourth port fluidly connecting the first fluid bladder to the second passage, wherein the first check valve is positioned in the second passage between the third port and the fourth port.

3. The assembly of claim 1, wherein the first check valve is in the first position during an inflation condition for the first fluid bladder and the second fluid bladder, and wherein the first check valve is in the second position during a deflation condition for the first fluid bladder and the second fluid bladder.

4. The assembly of claim 1, wherein a cross-sectional flow area of the first port is greater than a cross-sectional flow area of the second port.

5. The assembly of claim 1, including:
a fluid supply source;
a valve assembly fluidly connecting the fluid supply source to the fluid manifold; and
one or more controllers selectively controlling the valve assembly between the first position and the second position.

6. The assembly of claim 5, wherein the valve assembly comprises a single three position valve.

7. The assembly of claim 5, including a connecting passage fluidly connecting the valve assembly to the first passage and the second passage.

8. The assembly of claim 1, wherein the plurality of bladders includes at least a third bladder, and further including:
a fifth port fluidly connecting the third fluid bladder to the first passage;
a sixth port fluidly connecting the third fluid bladder to the second passage; and
a second check valve positioned in the second passage between the third port and the sixth port, the second check valve being moveable between a first position where fluid enters the sixth port and inflates the third fluid bladder, and a second position where fluid is directed through the sixth port to the vent.

9. The assembly of claim 8, wherein the plurality of bladders includes at least a fourth bladder, and further including:
a seventh port fluidly connecting the fourth fluid bladder to the first passage;
an eighth port fluidly connecting the fourth fluid bladder to the second passage; and
a third check valve positioned in the second passage between the sixth port and the eighth port, the third check valve being moveable between a first position where fluid enters the eighth port and inflates the fourth fluid bladder, and a second position where fluid is directed through the eighth port to the vent.

10. The assembly of claim 1, wherein the plurality of fluid bladders including the first fluid bladder and the second fluid bladder comprise a first set of fluid bladders, and wherein the fluid manifold includes a third passage, and further including:
a second set of fluid bladders comprising at least a third fluid bladder and a fourth fluid bladder, the second set of fluid bladders being in a parallel fluid flow arrangement with the first set of fluid bladders;
a fourth port fluidly connecting the third fluid bladder to the third passage;
a fifth port fluidly connecting the fourth fluid bladder to the third passage;
a sixth port fluidly connecting the fourth fluid bladder to the second passage; and
wherein, when the first check valve is in the first position, where fluid enters the third port and the sixth port and inflates the second fluid bladder and the fourth fluid bladder, and when the first check valve is in the second position, fluid is directed through the third port and the sixth port to the vent.

11. The assembly of claim 1, including a seat component comprising an exterior facing surface, and wherein the first fluid bladder and the second fluid bladder are positioned adjacent to the exterior facing surface.

12. A seat assembly comprising:
a seat component comprising an exterior facing surface;
a plurality of fluid bladders associated with the exterior facing surface, the plurality of fluid bladders including at least a first fluid bladder and a second fluid bladder;
a fluid manifold fluidly connecting a fluid supply source with the plurality of bladders, wherein the fluid manifold includes at least a first passage and a second passage;
a valve assembly fluidly connecting the fluid supply source to the fluid manifold;
a first port fluidly connecting the first fluid bladder to the first passage;
a second port fluidly connecting the second fluid bladder to the first passage;
a third port fluidly connecting the second fluid bladder to the second passage; and
a first check valve positioned in the second passage, wherein the first check valve is moveable between a first position where fluid enters the third port and inflates the second fluid bladder, and a second position where fluid is directed through the third port to a vent; and
one or more controllers selectively controlling the valve assembly between the first position and the second position.

13. The seat assembly of claim 12, including a fourth port fluidly connecting the first fluid bladder to the second passage, wherein the first check valve is positioned in the second passage between the third port and the fourth port.

14. The seat assembly of claim 12, wherein the first check valve is in the first position during an inflation condition for the first fluid bladder and the second fluid bladder, and wherein the first check valve is in the second position during a deflation condition for the first fluid bladder and the second fluid bladder.

15. The seat assembly of claim 12, wherein a cross-sectional flow area of the first port is greater than a cross-sectional flow area of the second port.

16. The seat assembly of claim 12, wherein the plurality of bladders includes at least a third bladder, and further including:
a fifth port fluidly connecting the third fluid bladder to the first passage;
a sixth port fluidly connecting the third fluid bladder to the second passage; and
a second check valve positioned in the second passage between the third port and the sixth port, the second check valve being moveable between a first position where fluid enters the sixth port and inflates the third fluid bladder, and a second position where fluid is directed through the sixth port to the vent.

17. The seat assembly of claim 16, wherein the plurality of bladders includes at least a fourth bladder, and further including:
a seventh port fluidly connecting the fourth fluid bladder to the first passage;
an eighth port fluidly connecting the fourth fluid bladder to the second passage; and
a third check valve positioned in the second passage between the sixth port and the eighth port, the third check valve being moveable between a first position where fluid enters the eighth port and inflates the fourth fluid bladder, and a second position where fluid is directed through the eighth port to the vent.

18. The seat assembly of claim 12, wherein the plurality of fluid bladders including the first fluid bladder and the second fluid bladder comprise a first set of fluid bladders, and wherein the fluid manifold includes a third passage, and further including:
a second set of fluid bladders comprising at least a third fluid bladder and a fourth fluid bladder, the second set of fluid bladders being in a parallel fluid flow arrangement with the first set of fluid bladders;
a fourth port fluidly connecting the third fluid bladder to the third passage;
a fifth port fluidly connecting the fourth fluid bladder to the third passage;
a sixth port fluidly connecting the fourth fluid bladder to the second passage; and
wherein, when the first check valve is in the first position, where fluid enters the third port and the sixth port and inflates the second fluid bladder and the fourth fluid bladder, and when the first check valve is in the second position, fluid is directed through the third port and the sixth port to the vent.

19. The seat assembly of claim 18, wherein the valve assembly comprises a single three position valve.

20. The seat assembly of claim 19, including a connecting passage fluidly connecting the valve assembly to the first passage, the second passage, and the third passage.
